(19) United States
(12) Patent Application Publication
(10) Pub. No.: US 2026/0270657 A1
(43) Pub. Date: Sep. 10, 2026

(54) ELECTRONIC DEVICE FOR RECEIVING MESSAGE USING NON-TERRESTRIAL NETWORK COMMUNICATION, AND OPERATING METHOD AND STORAGE MEDIUM THEREOF

(71) Applicant: SAMSUNG ELECTRONICS CO., LTD., Suwon-si (KR)

(72) Inventors: Changseok LEE, Suwon-si (KR); Dongsuk JUNG, Suwon-si (KR); Suyong YANG, Suwon-si (KR)

(73) Assignee: SAMSUNG ELECTRONICS CO., LTD., Suwon-si (KR)

(21) Appl. No.: 19/447,453

(22) Filed: Jan. 13, 2026

Related U.S. Application Data
(63) Continuation of application No. PCT/KR2025/023004, filed on Dec. 29, 2025.

(30) Foreign Application Priority Data
Jan. 17, 2025 (KR) 10-2025-0007135
Mar. 7, 2025 (KR) 10-2025-0030046

(51) Int. Cl. H04W 4/14; H04W 84/06

(52) U.S. Cl. CPC H04W 4/14; H04W 84/06

(57) ABSTRACT

An electronic device is provided. The electronic device comprises communication circuitry; at least one processor including processing circuitry; and memory storing instructions that, when executed by the at least one processor individually or collectively, cause the electronic device to: after a satellite for a non-terrestrial network (NTN) service is connected, identify that the NTN service is lost, after the NTN service is identified as lost, identify that the NTN service is recovered, based on identification that the NTN service is recovered, automatically transmit, to the satellite, via the communication circuitry, a signal for causing transmission of one or more messages which failed to be transmitted to the electronic device during a time period between a first time point at which the NTN service is lost and a second time point at which the NTN service is recovered, and receive, from the satellite, via the communication circuitry, the one or more messages.

### CROSS-REFERENCE TO RELATED APPLICATIONS

This application is a continuation of International Application No. PCT/KR2025/023004 designating the United States, filed on filed on Dec. 29, 2025, in the Korean Intellectual Property Receiving Office and claiming to Korean Patent Application No. 10-2025-0007135 filed on Jan. 17, 2025 and Korean Patent Application No. 10-2025-0030046 filed on Mar. 7, 2025, the disclosures of each of which are incorporated by reference herein in their entireties.

### BACKGROUND

### 1. Technical Field

An embodiment of the present disclosure relates to an electronic device for supporting a non-terrestrial network (NTN) communication, and an operating method and storage medium hereof.

### 2. Description of Related Art

An electronic device may support a non-terrestrial network (NTN) communication (e.g., a satellite communication). For example, the electronic device may communicate with a satellite of an existing satellite communication company using a frequency and a communication scheme of the satellite communication company. The electronic device may communicate with a satellite by using a cellular frequency according to a long-term evolution (LTE) standard (or, a 5^{th} generation (5G) standard) based on the LTE standard. The electronic device may also communicate with a satellite based on a 5G NTN standard.

If the electronic device performs a communication with an NTN based on the LTE standard, some of frequencies defined in the LTE standard may be allocated to a non-terrestrial communication. The electronic device may perform a satellite communication using a protocol stack used in a terrestrial communication, and an additional protocol stack for the non-terrestrial communication may not be required. The electronic device may perform a communication without distinguishing between the non-terrestrial communication and the terrestrial communication. For example, the electronic device may perform cell scan, camp on a cell which satisfies cell selection criteria, and perform an operation for accessing a network (e.g., camp on, a random access (RA) procedure, a connection establishment procedure, and/or attach (or registration)). The electronic device may perform an operation for camping on a cell which satisfies cell selection criteria and an operation for accessing a network without distinguishing between the non-terrestrial communication and the terrestrial communication. Accordingly, in substantially the same manner as the terrestrial communication, the electronic device may prepare for performing the non-terrestrial communication.

The above information may be provided as a related art for the purpose of aiding understanding of the present disclosure. No claim or determination has been made as to whether any of the foregoing may be applied as a prior art related to the present disclosure.

### SUMMARY

According to an aspect of the present disclosure, the electronic device may comprise communication circuitry; at least one processor including processing circuitry; and memory storing instructions that, when executed by the at least one processor individually or collectively, cause the electronic device to: after a satellite for a non-terrestrial network (NTN) service is connected, identify that the NTN service is lost, after the NTN service is identified as lost, identify that the NTN service is recovered, based on identification that the NTN service is recovered, automatically transmit, to the satellite, via the communication circuitry, a signal for causing transmission of one or more messages which failed to be transmitted to the electronic device during a time period between a first time point at which the NTN service is lost and a second time point at which the NTN service is recovered, and receive, from the satellite, via the communication circuitry, the one or more messages.

The one or more messages may comprise at least one short message service (SMS) message. The signal may comprise a dummy SMS message, a destination of the dummy SMS message comprising a phone number corresponding to the electronic device. The instructions, when executed by the at least one processor individually or collectively, may cause the electronic device to receive, via the communication circuitry, the dummy SMS message and the one or more messages failed to be transmitted to the electronic device during the time period between the first time point at which the NTN service is lost and the second time point at which the NTN service is recovered.

The instructions, when executed by the at least one processor individually or collectively, may cause the electronic device to, based on the time period between the first time point at which the NTN service is lost and the second time point at which the NTN service is recovered being shorter than a threshold time period, transmit, to the satellite, via the communication circuitry, the signal for causing transmission of the one or more messages which failed to be transmitted to the electronic device during the time period between the first time point at which the NTN service is lost and the second time point at which the NTN service is recovered. The threshold time period may correspond to a value for storing information associated with a failure of message transmission by the satellite.

The threshold time period may be defined by an operator of the NTN service.

The one or more messages, which failed to be transmitted to the electronic device during the threshold time period, may be received from the satellite.

The signal may comprise at least one of a non-internet protocol (IP) data delivery (NIDD) service request, a tracking area update (TAU) request, or a dummy short message service (SMS) message.

The one or more messages may comprise at least one of a short message service (SMS) message, a multimedia messaging service (MMS) message, or a rich communication service (RCS) message.

According to an aspect of the present disclosure, a method of operating an electronic device may comprise: after connecting to a satellite for a non-terrestrial network (NTN) service, identifying that the NTN service is lost; after identifying that the NTN service is lost, identifying that the NTN service is recovered; based on identifying that the NTN service is recovered, automatically transmitting, to the satellite, a signal for causing transmission of one or more messages which failed to be transmitted to the electronic device during a time period between a first time point at which the NTN service is lost and a second time point at which the NTN service is recovered; and receiving, from the satellite, the one or more messages.

The one or more messages may comprise at least one short message service (SMS) message. The signal may comprises a dummy SMS message, a destination of the dummy SMS message including a phone number corresponding to the electronic device. Receiving, from the satellite, the one or more messages may comprise receiving the dummy SMS message and the one or more messages which failed to be transmitted to the electronic device during the time period between the first time point at which the NTN service is lost and the second time point at which the NTN service is recovered.

Automatically transmitting, to the satellite, the signal may further comprise, based on the time period between the first time point at which the NTN service is lost and the second time point at which the NTN service is recovered being shorter than a threshold time period, transmitting, to the satellite, the signal for causing transmission of the one or more messages which failed to be transmitted to the electronic device during the time period between the first time point at which the NTN service is lost and the second time point at which the NTN service is recovered. The threshold time period may correspond to a value for storing information associated with a failure of message transmission by the satellite.

The threshold time period may be defined by an operator of the NTN service.

The signal may include at least one of a non-internet protocol (IP) data delivery (NIDD) service request, a tracking area update (TAU) request, or a dummy short message service (SMS) message.

The one or more messages may include at least one of a short message service (SMS) message, a multimedia messaging service (MMS) message, or a rich communication service (RCS) message.

According to an aspect of the present disclosure, a non-transitory storage medium storing computer-readable instructions, the instructions, when executed by at least one processor of an electronic device, may cause the electronic device to: after connecting to a satellite for a non-terrestrial network (NTN) service, identify that the NTN service is lost; after identifying that the NTN service is lost, identify that the NTN service is recovered; based on identifying that the NTN service is recovered, automatically transmit, to the satellite, a signal for causing transmission of one or more messages which failed to be transmitted to the electronic device during a time period between a first time point at which the NTN service is lost and a second time point at which the NTN service is recovered; and receive, from the satellite, at least one of the one or more messages.

The one or more messages may comprise at least one short message service (SMS) message. The signal may comprise a dummy SMS message. A destination of the dummy SMS message may comprise a phone number corresponding to the electronic device. The instructions that cause the electronic device to receive, from the satellite, the at least one of the one or more messages may comprise instructions to further cause the electronic device to receive the dummy SMS message and the one or more messages which failed to be transmitted to the electronic device during the time period between the first time point at which the NTN service is lost and the second time point at which the NTN service is recovered.

The instructions that cause the electronic device to automatically transmit, to the satellite, the signal may further comprise instructions to cause the electronic device to, based on the time period between the first time point at which the NTN service is lost and the second time point at which the NTN service is recovered being shorter than a threshold time period, transmit, to the satellite, the signal for causing transmission of the one or more messages which failed to be transmitted to the electronic device during the time period between the first time point at which the NTN service is lost and the second time point at which the NTN service is recovered. The threshold time period may correspond to a value for storing information associated with a failure of message transmission by the satellite.

The threshold time period may be defined by an operator of the NTN service.

The one of the one or more messages, which failed to be transmitted to the electronic device during the threshold time period, may be received from the satellite.

The signal may comprise at least one of a non-internet protocol (IP) data delivery (NIDD) service request, a tracking area update (TAU) request, or a dummy short message service (SMS) message.

### BRIEF DESCRIPTION OF DRAWINGS

Various techniques will be described with reference to the drawings, in which:

FIG. 1 is a block diagram illustrating an electronic device in a network environment according to an embodiment of the present disclosure;

FIG. 2 is a diagram illustrating an electronic device and a long-range communication network environment according to an embodiment of the present disclosure;

FIG. 3 is a diagram for describing an access of an electronic device according to an embodiment of the present disclosure;

FIG. 4 is a diagram for describing a non-terrestrial network (NTN) system according to an embodiment of the present disclosure;

FIG. 5 is a diagram for describing a method for an electronic device to receive a message according to an embodiment of the present disclosure;

FIG. 6 is a diagram for describing an operating method of an electronic device according to an embodiment of the present disclosure;

FIG. 7 is a diagram for describing a method for an electronic device to receive a pending message from an SMS server according to an embodiment of the present disclosure;

FIG. 8 is a diagram for describing an operating method of an electronic device according to an embodiment of the present disclosure;

FIG. 9 is a diagram for describing an operating method of an electronic device according to an embodiment of the present disclosure;

FIG. 10 is a diagram for describing an operating method of an electronic device according to an embodiment of the present disclosure;

FIG. 11 is a diagram for describing an operating method of an electronic device according to an embodiment of the present disclosure;

FIG. 12A is a diagram for describing an operating method of an electronic device according to an embodiment of the present disclosure; and

FIG. 12B is a diagram for describing an operating method of an electronic device according to an embodiment of the present disclosure.

### DETAILED DESCRIPTION

An embodiment of the disclosure will be described in detail with reference to the accompanying drawings. In the following description of an embodiment of the present disclosure, a detailed description of relevant known functions or configurations incorporated herein will be omitted when it is determined that the description may make the subject matter of an embodiment of the present disclosure unnecessarily unclear. The terms which will be described below are terms defined in consideration of the functions in the present disclosure, and may be different according to users, intentions of the users, or customs. Therefore, the definitions of the terms should be based on contents throughout the present disclosure.

It should be noted that the technical terms used herein are only used to describe a specific embodiment, and are not intended to limit an embodiment of the disclosure. Alternatively, the technical terms used herein should be interpreted to have the same meaning as those commonly understood by a person skilled in the art to which the present disclosure pertains, and should not be interpreted have excessively comprehensive or excessively restricted meanings unless particularly defined as other meanings. Alternatively, when the technical terms used herein are wrong technical terms that cannot correctly represent the idea of the present disclosure, it should be appreciated that they are replaced by technical terms correctly understood by those skilled in the art. Alternatively, the general terms used in an embodiment of the disclosure should be interpreted as defined in dictionaries or interpreted in the context of the relevant embodiment of the present disclosure, and should not be interpreted to have excessively restricted meanings.

A singular expression used herein may include a plural expression unless they are definitely different in the context. Use of terms such as “a” and “an” and “the” and similar referents in context of describing disclosed embodiments (especially in context of following claims) are to be construed to cover both singular and plural, unless otherwise indicated herein or clearly contradicted by context, and not as a definition of a term.

As used herein, such an expression as “comprises,” “has,” “consists,” or “include,” or the like should not be interpreted to necessarily include all elements or all operations described in the specification, and should be interpreted to be allowed to exclude some of them or further include additional elements or operations.

Terms such as “first,” “second,” “third,” “fourth,” etc. are used merely to distinguish elements from one another and thus do not denote any particular order unless an order is specifically described. For example, the term “second” may be used without using the term “first”. Also, although the terms “first,” “second,” “third,” and so on may be used herein to describe various elements, components, regions, layers and/or sections, these elements, components, regions, layers and/or sections should not be limited by these terms.

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

Use of any and all examples, or exemplary language provided herein, is intended merely to better illuminate embodiments of disclosure and does not pose a limitation on scope of disclosure unless otherwise claimed. No language in specification should be construed as indicating any non-claimed element as essential to practice of disclosure.

Terms such as “set” (e.g., “a set of items”) or “subset” unless otherwise noted or contradicted by context, are to be construed as a nonempty collection comprising one or more members. Further, unless otherwise noted or contradicted by context, term “subset” of a corresponding set does not necessarily denote a proper subset of corresponding set, but subset and corresponding set may be equal.

In addition, unless otherwise noted or contradicted by context, term “plurality” indicates a state of being plural (e.g., “a plurality of items” indicates multiple items). Number of items in a plurality is at least two, but can be more when so indicated either explicitly or by context. Further, unless stated otherwise or otherwise clear from context, phrase “based on” means “based at least in part on” and not “based solely on.”

An embodiment of the present disclosure will be described in detail with reference to the accompanying drawings. Regardless of drawing signs, the same or like elements are provided with the same reference numeral, and a repeated description thereof will be omitted. Alternatively, in describing an embodiment of the disclosure, a detailed description of relevant known technologies will be omitted when it is determined that the description may make the subject matter of the present disclosure unclear. Alternatively, it should be noted that the accompanying drawings are presented merely to help easy understanding of the technical idea of the present disclosure, and should not be construed to limit the technical idea of the present disclosure. The technical idea of the present disclosure should be construed to cover all changes, equivalents, and alternatives, in addition to the drawings.

In various examples, an electronic device may refer to a terminal, a mobile station, a mobile equipment (ME), a user equipment (UE), a user terminal (UT), a subscriber station (SS), a wireless device, a handheld device, or an access terminal (AT). Alternatively, in an embodiment of the present disclosure, the electronic device may be a device having a communication function such as, for example, a mobile phone, a personal digital assistant (PDA), a smart phone, a wireless MODEM, or a notebook.

In many examples, a base station may refer to at least one of a gNode B, a gNB, an eNode B, an eNB, a Node B, a BS, a wireless access unit, a base station controller, or a node on a network. The base station may also be a network entity including at least one of an integrated access and backhaul-donor (IAB-donor), which is a gNB that provides network access to an electronic device(s) through a network of backhaul and access links in a new radio (NR) system, and an IAB-node, which is a radio access network (RAN) node that supports NR access link(s) to the electronic device(s) and supports NR backhaul links to the IAB-donor or another IAB-node. In an embodiment of the present disclosure, an electronic device may be wirelessly accessed through an IAB-node and may transmit and receive data to and from an IAB-donor connected via a backhaul link with at least one IAB-node.

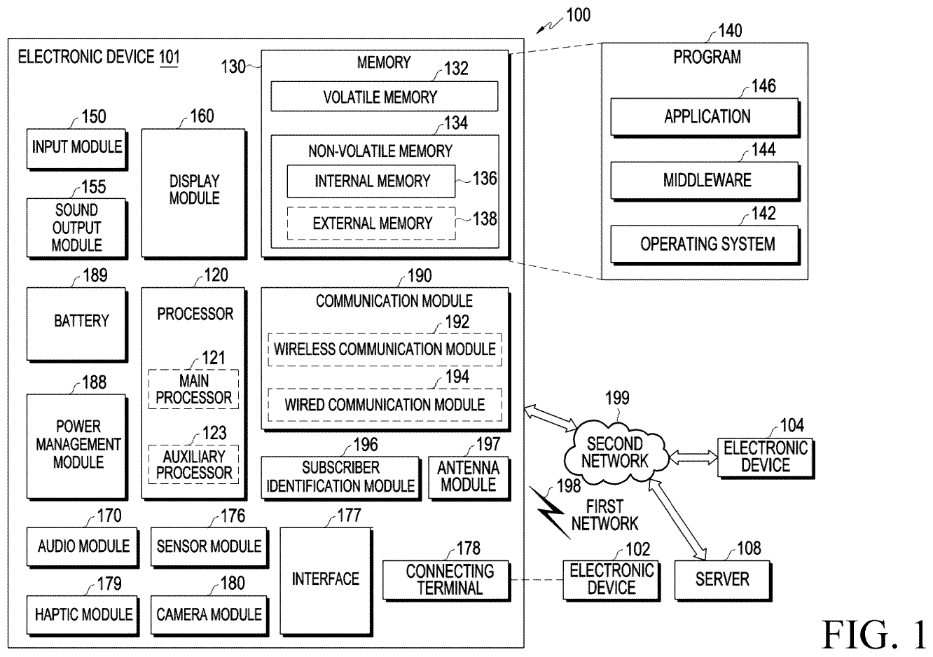

FIG. 1 is a block diagram illustrating an electronic device 101 in a network environment 100 according embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may acquire the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless fidelity (WiFi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to some embodiments, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

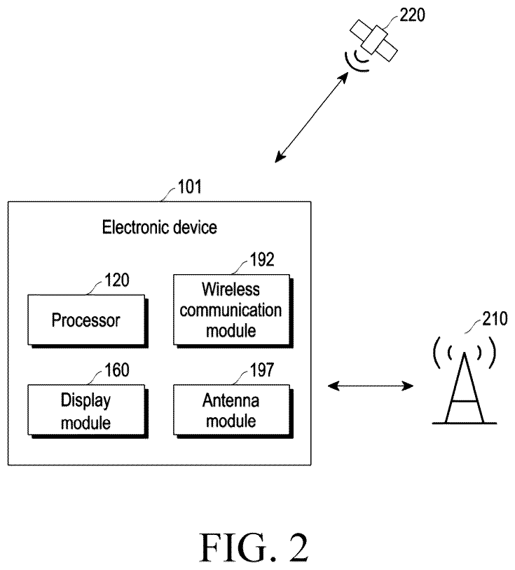

FIG. 2 is a diagram illustrating an electronic device and a long-range communication network environment according to an embodiment of the present disclosure.

An electronic device 101 may transmit and/or receive data via a terrestrial network and/or a non-terrestrial network (NTN). The electronic device 101 may have the same as the configuration of the electronic device 101 illustrated in FIG. 1 or may include the configuration of the electronic device 101 illustrated in FIG. 1.

The terrestrial network may refer to a network capable of providing a data communication via a terrestrial wireless communication device 210. For example, the terrestrial wireless communication device 210 may include a base station located on the ground (e.g., fixed to the ground). The terrestrial wireless communication device 210 may support at least one of various communication schemes supportable by the electronic device 101. For example, the terrestrial wireless communication device 210 may include an eNodeB (e.g., an LTE-based base station) or a gNodeB (e.g., a 5G (or NR)-based base station), but is not limited thereto.

The NTN may refer to a network capable of providing a data communication via at least one non-terrestrial wireless communication device 220. For example, the non-terrestrial wireless communication device 220 may include at least one of various communication devices such as a base station and a repeater which are not located on the ground. For example, the non-terrestrial wireless communication device 220 may include a satellite and/or an unmanned aerial vehicle, but is not limited thereto. For example, the satellite may include a low-earth orbit (LEO) satellite, a medium-earth orbit (MEO) satellite, a geostationary earth orbit (GEO) satellite, and/or a high elliptical orbit (HEO) satellite. For example, the satellite may include an orbiting satellite and/or a geostationary satellite.

The non-terrestrial wireless communication device 220 may support at least one of various wireless communication schemes. For example, the non-terrestrial wireless communication device 220 may support an NR NTN defined by 3rd generation partnership project (3GPP). Alternatively, the non-terrestrial wireless communication device 220 may support at least one of communication schemes based on various communication standards such as LTE, global system for mobile communications (GSM), or code-division multiple access (CDMA), but is not limited thereto.

The terrestrial network and the NTN may be networks independent of each other. Alternatively, the terrestrial network and the NTN may be included in at least one network (e.g., a network provided by the same provider) associated with each other.

If a communication with the terrestrial network is not possible or is not seamless, the electronic device 101 may perform a wireless communication via the NTN. Alternatively, the electronic device 101 may perform a wireless communication via the NTN regardless of a communication state with the terrestrial network.

According to an embodiment, the electronic device 101 may include a processor 120, a display module 160 (e.g., a display), a wireless communication module 192 (e.g., a communication circuit), and/or an antenna module 197. For example, the processor 120 may be operatively, functionally, and/or electrically connected to the display module 160, the wireless communication module 192, and/or the antenna module 197.

The processor 120 may execute, e.g., instructions (e.g., a program 140 in FIG. 1) at least temporarily stored in memory (e.g., memory 130 in FIG. 1) to control at least one other component (e.g., a hardware or software component) of the electronic device 101 connected to the processor 120, and may perform various data processing or computation. According to an embodiment of the present disclosure, the processor 120 may control the overall operation related to a terrestrial network communication and/or NTN communication. For example, the processor 120 may include a communication processor (e.g., an auxiliary processor 123 in FIG. 1) related to the terrestrial network communication and/or NTN communication.

The display module 160 may visually provide information to the outside (e.g., a user) of the electronic device 101.

According to an embodiment of the present disclosure, the display module 160 may display a user interface (UI) indicating information related to the terrestrial network and/or a NTN. For example, the UI indicating the information related to the terrestrial network and/or the NTN may include at least one of UIs indicating information related to a type of a network (e.g., cellular communication (3G, 4G, or 5G), short-range communication (e.g., BT, or WI-FI), or satellite communication), a type of network service provider (e.g., satellite communication service provider (Iridium), emergency service provider (ESP)), strength of a network signal (e.g., signal strength bars, RSSI, or RSRP), a direction of a communication device (satellite) included in a network (e.g., an orientation, an elevation angle, or an azimuth angle), presence information, and/or a network communication state (e.g., idle, transmit, or receive).

According to an embodiment of the present disclosure, the display module 160 may display a UI indicating a service related to the terrestrial network and/or the NTN.

According to an embodiment of the present disclosure, the service related to the terrestrial network and/or the NTN may include at least one of, an emergency message transmission service, a messaging service, a voice call, a video call, a data communication service, a location-related service, and/or a service related to an indicator.

According to an embodiment of the present disclosure, the emergency message transmission service may include, but is not limited to, at least one of an SOS service state information providing service (e.g., display whether it is possible to provide an SOS service), a government office information providing service, an emergency contact information providing service, a text template providing service that minimizes text entry of the user, or a questionnaires service (e.g., a service for providing questionnaires, such as accident type, injured area, or medical information (e.g., age, gender, disease information, or medication information)) for quickly notification of the emergency.

According to an embodiment of the present disclosure, the messaging service may include at least one of a short message service (SMS), a multimedia messaging service (MMS), or a rich communication suite (RCS) message, but is not limited thereto.

According to an embodiment of the present disclosure, the data communication service may include a service via various applications (e.g., a web browser) that provide a data communication.

According to an embodiment of the present disclosure, the location-related service may include, but is not limited to, at least one of longitude/latitude coordinates, location-related map information about the non-terrestrial communication device 220, navigation, or a street view.

According to an embodiment of the present disclosure, the UI example is not limited to the above-mentioned example, and may be provided via another output device (e.g., a sound output module 155 in FIG. 1).

According to an embodiment of the present disclosure, the wireless communication module 192 may support various types of wireless communication bands supported by the electronic device 101. For example, a wireless communication band supported by the electronic device 101 may include a short-range wireless communication band (e.g., BT or Wi-Fi), a terrestrial network (e.g., cellular network) communication band, and/or an NTN band, but is not limited thereto.

According to an embodiment of the present disclosure, the electronic device 101 may support a frequency band (e.g., n255, or n256) related to an NTN wireless communication. The electronic device 101 may perform the NTN wireless communication using a frequency band related to NTN wireless communication, but is not limited thereto. For example, the electronic device 101 may perform the NTN wireless communication using at least a portion of the frequency band related to a terrestrial network wireless communication.

According to an embodiment of the present disclosure, the antenna module 197 may transmit or receive a signal or power to or from the outside (e.g., an external electronic device.

According to an embodiment of the present disclosure, the electronic device 101 may perform a wireless communication with the NTN using at least one antenna among a plurality of antennas included in the antenna module 197. At least one antenna supporting the NTN communication may include a dedicated antenna and/or a multi-use antenna. The dedicated antenna may include an antenna supporting the NTN. The multi-use antenna may include an antenna that supports different types of networks and NTNs together. For example, the electronic device 101 may communicate with at least one satellite (e.g., a GNSS satellite or a satellite for emergency message service) using at least one NTN-dedicated antenna. For example, the multi-use antenna may include an antenna supporting a short-range communication network (e.g., a Bluetooth network or a Wi-Fi network) and/or a terrestrial network (e.g., a long term evolution (LTE) network). The electronic device 101 may support a NTN using a plurality of antennas among antennas supporting the terrestrial network.

According to an embodiment of the present disclosure, a satellite is mainly mentioned as the non-terrestrial wireless communication device 220, and even if it is mentioned that the satellite provides a wireless communication using a specific radio access technology (RAT) (e.g., LTE) or a specific function (e.g., a base station), this is merely an example, and the type thereof is not limited.

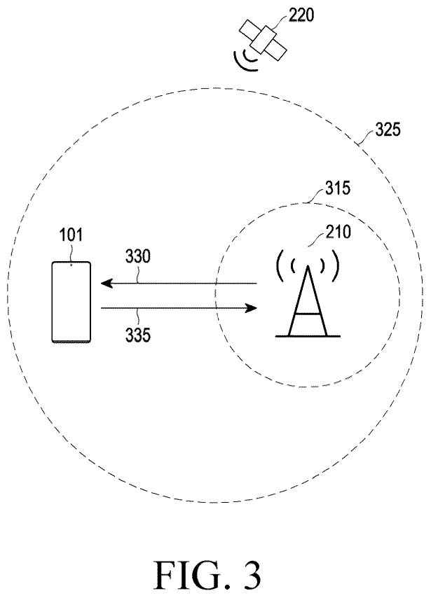

FIG. 3 is a diagram for describing an access of an electronic device according to an embodiment.

According to an embodiment of the present disclosure, an electronic device 101 may be located within a coverage 315 (hereinafter, referred to as a terrestrial wireless communication coverage 315) of a terrestrial wireless communication device 210 and/or a coverage 325 (hereinafter, referred to as a non-terrestrial wireless communication coverage 325) of a non-terrestrial wireless communication device 220. The non-terrestrial wireless communication coverage 325 may be relatively larger (e.g., 50 times larger) than the terrestrial wireless communication coverage 315. For example, the non-terrestrial wireless communication coverage 325 may cover an area not covered by the coverage 315 of the terrestrial wireless communication device 210, and accordingly, the electronic device 101 may perform a communication even in an area where a terrestrial wireless communication is not supported.

According to an embodiment of the present disclosure, the electronic device 101 may perform a cell scan within the terrestrial wireless communication coverage 315 and/or the non-terrestrial wireless communication coverage 325. As a result of performing the cell scan, the electronic device 101 may identify a cell provided by the terrestrial wireless communication device 210 and/or a cell provided by the non-terrestrial wireless communication device 220. If there is a cell that meets cell selection criteria, the electronic device 101 may perform at least some of operations for connecting to a network (e.g., an NTN and/or a terrestrial network). Here, the connection to the network may include, e.g., at least some of a preceding operation (e.g., camping-on, or connection procedure (e.g., random access (RA) procedure)) for registration to the network and/or a registration operation (e.g., attach, or registration)) to the network, but is not limited thereto. If disconnection from the network is required (e.g., movement to another network), the electronic device 101 may perform at least some of disconnecting operations. The operations for disconnecting from the network may include at least some of a detach from the network, release of connection, and/or radio link failure (RLF) declaration, and is not limited to the listed operations.

According to an embodiment, the electronic device 101 may perform at least some of cell scan, disconnection from the network, and/or connection to the network according to movement 330 or 335.

According to an embodiment, if the electronic device 101 is located within the terrestrial communication coverage 315 included in the non-terrestrial wireless communication coverage 325 or is located at a boundary area of the terrestrial communication coverage 315, the electronic device 101 may connect to the terrestrial network and/or the NTN based on a policy (e.g., a priority policy) of the electronic device 101.

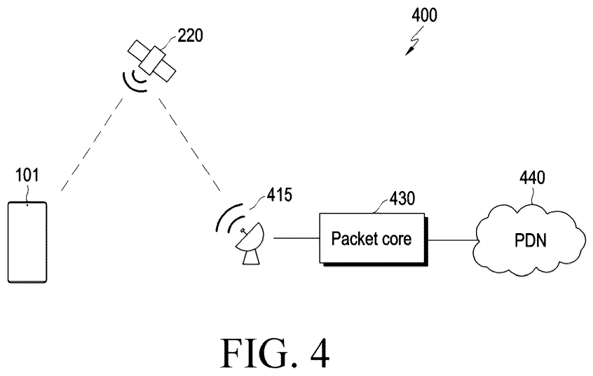

FIG. 4 is a diagram for describing an NTN system 400 according to an embodiment.

Referring to FIG. 4, a NTN system 400 may include a non-terrestrial wireless communication device 220, a radio unit 415, a packet core 430, and/or a PDN 440.

According to an embodiment of the present disclosure, the NTN system 400 may be implemented, e.g., in a regenerative scheme. When implemented in a regenerative scheme, the at least one non-terrestrial wireless communication device 220 may include a base station (e.g., eNode B). The NTN system 400 may be implemented, e.g., in a bent-pipe scheme. The bent-pipe scheme may include a passive relay scheme that performs frequency conversion and power amplification on a received signal. If the NTN system 400 is implemented in a bent-pipe scheme, the at least one non-terrestrial wireless communication device 220 may include a relay that converts (for example, amplifies) and transmits a signal. An implementation scheme of the NTN system 400 and a role of the non-terrestrial wireless communication device 220 described in FIG. 4 are merely examples, and are not limited thereto.

According to an embodiment of the present disclosure, the non-terrestrial wireless communication device 220 may include at least one satellite. The non-terrestrial wireless communication device 220 may communicate with, e.g., the electronic device 101 using a terrestrial network (e.g., a cellular network) band and/or an NTN band. The terrestrial network band may be, e.g., an operating band supported by long term evolution (LTE) and/or new radio (NR), but is not limited thereto. The NTN band may include a band (e.g., n255 and/or n256 bands) defined by 3GPP, but is not limited thereto.

According to an embodiment of the present disclosure, the at least one radio unit 415 may receive a signal of the non-terrestrial wireless communication device 220 and transmit the signal to the packet core 430. The radio unit 415 and the non-terrestrial wireless communication device 220 may perform a communication using, e.g., the NTN band. The NTN band may be different from the terrestrial network band, but may be set to be the same in some cases.

According to an embodiment, the at least one packet core 430 may transmit and receive data associated with the electronic device 101 using the radio unit 415. Accordingly, the packet core 430 may process the data associated with the electronic device 101 and transmit the processed data to a packet data network (PDN) 440 (e.g., the Internet). The packet core 415 may include, e.g., at least some of an evolved packet core (EPC) and/or a 5G core (5GC), but is not limited thereto. The packet core 430 may include a packet core associated with an operator of the non-terrestrial wireless communication device 220 and/or a packet core associated with a mobile network operator (MNO). The packet core 430 may be additionally connected to a public switched telephone network (PSTN) (not shown) to transmit and receive data associated with the electronic device 101.

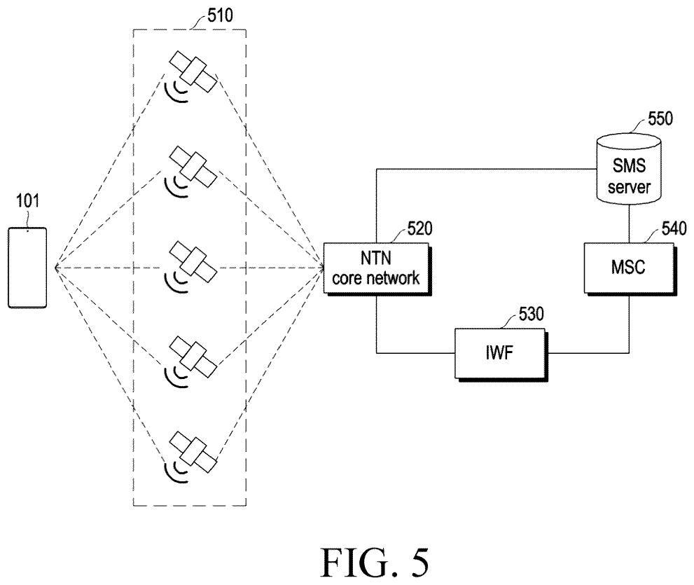

FIG. 5 is a diagram for describing a method for an electronic device to receive a message according to an embodiment.

In an embodiment of the present disclosure, an electronic device 101 may perform a non-terrestrial wireless communication with at least one (e.g., a satellite eNB) of a plurality of non-terrestrial wireless communication devices 510. The electronic device 101 may support an NB IoT NTN service, and the non-terrestrial wireless communication is not limited thereto. For example, the electronic device 101 may perform a peer-to-peer connection with the satellite eNB based on performing a positioning operation (e.g., position pointing). The plurality of non-terrestrial wireless communication devices 510 may be connected to an NTN core network (520) (or a satellite core entity). The NTN core network 520 may provide the electronic device 101 with a satellite service via the plurality of non-terrestrial wireless communication devices 510. The NTN core network 520 may be connected to network entities of a terrestrial communication (TN) operator. The network entities of the terrestrial telecommunication operator may include an inter working function (IWF) 530, a mobile switching center (MSC) 540, and/or an SMS server 550 (or an SMS center). The IWF 530 may include an interface, such as SGd or SGs. The SGd may be, for example, an interface for SMS delivery between a mobility management entity (MME) and the SMS server 550. The SGs may be an interface between the MSC 540 (e.g., a 2G (GERAN) and a 3G (UTRAN) MSC) and the MME (e.g., long term evolution (LTE) and an evolved packet core (EPC) MME). The NTN core network 520 may provide an SMS transmission and reception service based on a connection with the SMS server 550. For example, transmission and reception of SMS messages between electronic devices may be performed through the SMS server 550, unlike a call service based on a P2P connection. For example, the electronic device 101 may perform transmission of an SMS message by transmitting phone number of a receiving end and SMS context to the SMS server 550. The electronic device 101 may display a received SMS message via a display based on receiving phone number of a transmitting end and the SMS context from the SMS server 550. In an embodiment of the present disclosure, the electronic device 101 may depend on a network for transmission and reception of an SMS. For example, SMS instances may be missed during a booting or software update process of the electronic device 101. An SMS instance may include message content and additional information (e.g., context). The context may include caller information, a timestamp, and/or information associated with a message type (e.g., marketing or notification), and there is no specific limitation on examples of the context. The MSC 540 or the SMS server 550 may store a delivery failed SMS as a pending SMS for a threshold time period. The electronic device 101 may lose the SMS message if the SMS instance is not retransmitted from the network.

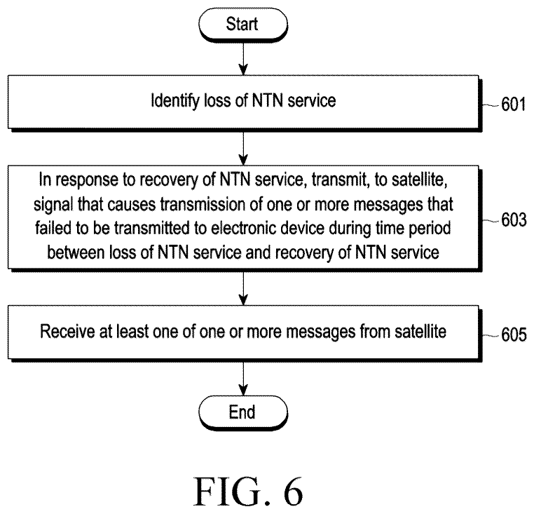

FIG. 6 is a diagram for describing an operating method of an electronic device according to an embodiment.

According to an embodiment of the present disclosure, an electronic device 101 may, in operation 601, identify loss of a NTN service. In an embodiment of the present disclosure, the electronic device 101 may be an electronic device which supports an NTN 3GPP and non-3GPP satellite communication. The electronic device 101 may use an NB-IoT NTN service if a wireless communication via a terrestrial network is not possible. The electronic device 101 may connect to (or access) a satellite for the NTN service (e.g., communication networks that utilize satellites or airborne vehicles to provide wireless connectivity). After connecting to the satellite for the NTN service, the electronic device 101 may identify that the NTN service is lost. The electronic device 101 may identify the loss of the NTN service based on, for example, identifying a decoding failure for a non-terrestrial wireless communication channel, and there is no limitation to a specific example. The electronic device 101 may include an application processor and a communication processor. The communication processor may identify the loss of the NTN service via the application processor, or identify the loss of the NTN service based on a received signal. The loss of the NTN service may occur by a grip event of the electronic device 101, a location (or height, or a direction) of the electronic device 101, and/or an obstacle between the electronic device 101 and the satellite (or the satellite eNB). In various examples, loss of a service may refer to as “no service,” “out-of-service (OOS),” interruption or termination of connectivity, and the service being unavailable, among others.

In an embodiment of the present disclosure, in response to recovery of the NTN service after the loss of the NTN service, the electronic device 101 may, in operation 603, transmit, to the satellite via a communication circuit (e.g., a wireless communication module 192 in FIG. 1 or FIG. 2), a signal which causes transmission of one or more messages which failed to be transmitted to the electronic device 101 during a time period between the loss of the NTN service and the recovery of the NTN service. The electronic device 101 may identify the recovery of the NTN service after the loss of the NTN service. The electronic device 101 may, for example, identify the recovery of the NTN service based on the non-terrestrial wireless communication channel being decoded normally. In various examples, recovery of a service may refer to restoration of connectivity and re-establishment of communication. A provider network which provides the NTN service after the recovery of the NTN service may correspond to the provider network which provided the NTN service before the loss of the NTN service. The electronic device 101 may automatically transmit the signal to the satellite without user input.

In an embodiment of the present disclosure, based on the time period between the loss of the NTN service and the recovery of the NTN service being less than a threshold time period, the electronic device 101 may transmit, to the satellite, the signal which causes the transmission of the one or more messages which failed to be transmitted to the electronic device during the time period between the loss of the NTN service and the recovery of the NTN service. The threshold time period may correspond to a value for storing information associated with failure of message transmission by the satellite. The threshold time period may be defined by the provider of the NTN service. The value corresponding to the threshold time period may be stored in the electronic device 101 (e.g., a processor 120 and/or memory 130 in FIG. 1). The threshold time period stored in the electronic device 101 may include a time period value set in response to the provider of the NTN service. The threshold time period value may be set, for example, in a range of several minutes, and there is no limitation on a specific numerical value. The threshold time period value may be changed by binary update and/or parameter update of the electronic device 101. The electronic device 101 may transmit, to the satellite (e.g., a non-terrestrial wireless communication device 220) via the communication circuit configured to transmit or receive a signal associated with an NTN communication, a signal to notify the NTN core network 520 of the recovery of the electronic device 101. The one or more messages which failed to be transmitted to the electronic device during the time period between the loss of the NTN service and the recovery of the NTN service may include, for example, at least one short message service (SMS) message. The signal which the electronic device 101 transmits to the satellite may include a dummy SMS message. A recipient of the dummy SMS may be a phone number corresponding to the electronic device 101. The dummy SMS message may be, for example, a blank message which is responded to the electronic device 101 after being delivered to the SMS server 550. The content of an SMS text (e.g., DU\#MMYSMS2BIG\#NORED\!) may be changed corresponding to a region or an NTN provider of the electronic device 101. The electronic device 101 may notify the NTN core network 520 of the recovery of the electronic device 101 by transmitting a dummy message (or user data). In an embodiment, the electronic device 101 may also transmit a message including parameters which notify the network of the recovery of the electronic device 101.

In an embodiment of the present disclosure, the signal transmitted by the electronic device 101 to the satellite in response to the recovery of the NTN service may include at least one of a non-IP data delivery (NIDD) service request, a tracking area update (TAU) request, or a dummy SMS message. For example, the signal transmitted by the electronic device 101 to the satellite in response to the recovery of the NTN service may include the NIDD service request. By transmitting the NIDD service request, the electronic device 101 may notify the NTN core network 520 of the recovery of the electronic device 101. The signal transmitted by the electronic device 101 to the satellite in response to the recovery of the NTN service may also include the TAU request. By transmitting the TAU request, the electronic device 101 may also notify the NTN core network 520 of the recovery of the electronic device 101. The electronic device 101 may also notify the NTN core network 520 of the recovery of the electronic device 101 by transmitting both the NIDD service request and the TAU request. The electronic device 101 may notify the NTN core network 520 of the recovery of the electronic device 101 by transmitting both the NIDD service request and the dummy SMS. The electronic device 101 may also notify the NTN core network 520 of the recovery of the electronic device 101 by transmitting both the TAU request and the dummy SMS. The electronic device 101 may also notify the NTN core network 520 of the recovery of the electronic device 101 by transmitting all of the NIDD service request, the TAU request, and the dummy SMS.

In an embodiment of the present disclosure, a messaging service is not limited to an SMS messaging service. For example, a message may include at least one of an SMS message, a Multimedia Messaging Service (MMS) message, or a Rich Communication Service (RCS) message.

In an embodiment of the present disclosure, without comparison to the threshold time, in response to the recovery of the NTN service, the electronic device 101 may also automatically transmit, to the satellite, the signal which causes the transmission of the one or more messages which failed to be transmitted to the electronic device during the time period between the loss of NTN service and the recovery of the NTN service.

In an embodiment of the present disclosure, the electronic device 101 may, in operation 605, receive a message from the satellite. The electronic device 101 may receive, via the communication circuit 192, the dummy SMS message and the one or more messages which failed to be transmitted to the electronic device during the time period between the loss of NTN service and the recovery of the NTN service. In response to the signal which causes the transmission of the one or more messages, the electronic device 101 may, receive, from the satellite via the communication circuit, at least one of the one or more messages which failed to be transmitted to the electronic device during the time period between the loss of NTN service and the recovery of the NTN service. The at least one of the one or more messages which failed to be received by the electronic device during the threshold time period may be sequentially received from the satellite. The message received from the satellite may include at least one SMS message stored in the SMS server during the time period between the loss of NTN service and the recovery of the NTN service. The electronic device 101 may induce retransmission of a missed SMS by notifying the NTN core network of the recovery of the electronic device 101. The electronic device 101 may increase possibility of receiving the missed SMS message during a period in which the NTN service is lost by transmitting, to the satellite, a signal which automatically induces the retransmission of the missed SMS without user input in response to the recovery of NTN service.

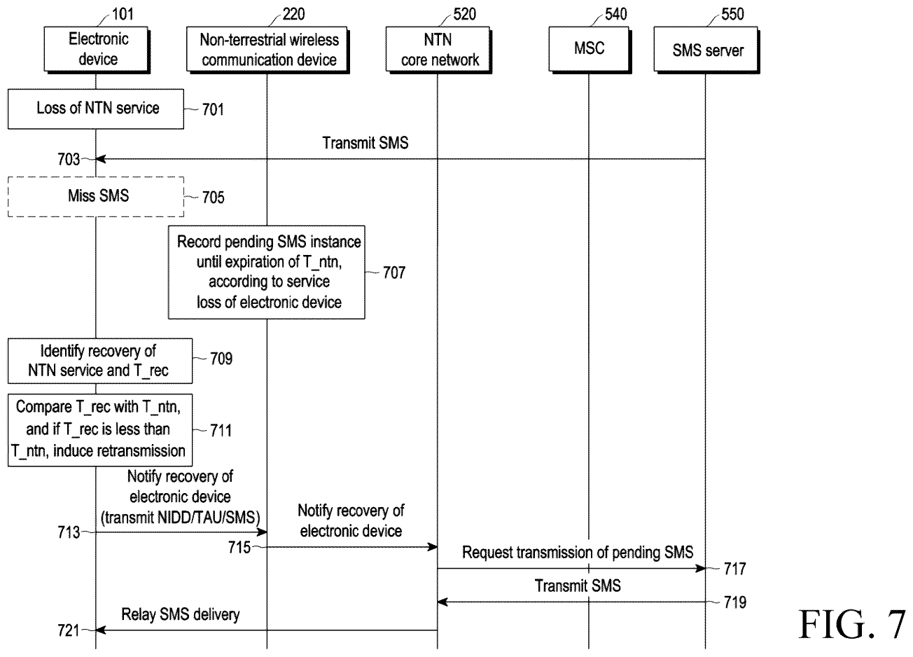

FIG. 7 is a diagram for describing a method for an electronic device to receive a pending message from an SMS server according to an embodiment of the present disclosure.

According to an embodiment of the present disclosure, an electronic device 101 may, in operation 701, identify loss of an NTN service.

In an embodiment of the present disclosure, an SMS server 550 may transmit an SMS message to the electronic device 101 in operation 703. In FIG. 7, the SMS server 550 is illustrated as directly transmitting the SMS message to the electronic device 101, but is not limited thereto. For example, the SMS server 550 may transmit the SMS message to the NTN core network 520. The NTN core network 520 may transmit the SMS message to a non-terrestrial wireless communication device 220. The non-terrestrial wireless communication device 220 may deliver the SMS message to the electronic device 101. Referring to reference numeral 705, the electronic device 101 may miss the SMS message because the electronic device 101 is in an NTN service loss state. The SMS server 550 may identify that SMS reception by the electronic device 101 failed based on signaling interaction established with the electronic device 101 not being completed.

In an embodiment of the present disclosure, the non-terrestrial wireless communication device 220 may, in operation 707, record service recovery of the electronic device 101 from the service loss to expiration of a timer (e.g., T_ntn). The non-terrestrial wireless communication device 220 may request retransmission of a pending SMS instance until the expiration of the timer. The non-terrestrial wireless communication device 220 may record the service loss and/or the service recovery of the electronic device 101. The non-terrestrial wireless communication device 220 may, for example, initiate the timer based on the service loss of the electronic device 101. The non-terrestrial wireless communication device 220 may store information indicating that there is a message (e.g., an SMS instance) which has not been received by the electronic device 101 until the expiration of the timer. The non-terrestrial wireless communication device 220 may transmit a request for the retransmission of the pending SMS instance if recovery of the electronic device 101 is identified before the timer expires. The non-terrestrial wireless communication device 220 may not transmit the request for the retransmission of the missed SMS message to the electronic device 101 after the timer expires.

In an embodiment of the present disclosure, the electronic device 101 may, in operation 709, identify recovery of an NTN service and a time period (e.g., T_rec) for the service loss.

In an embodiment of the present disclosure, the electronic device 101, in operation 711, may compare the time period T_rec for the service loss with the timer T_ntn, and induce retransmission if a value of the time period (T_rec) for the service loss is less than a value of the timer (T_ntn).

In an embodiment, of the present disclosure the electronic device 101 may, at operation 713, notify the non-terrestrial wireless communication device 220 of the recovery of the electronic device 101. The electronic device 101 may notify the recovery of the electronic device 101 based on, for example, at least one of an NIDD service request, a TAU request, or a dummy SMS message. For example, the electronic device 101 may transmit the dummy SMS including user data (e.g., SMS text) set based on an agreement with an NTN provider or a TN provider, to the non-terrestrial wireless communication device 220. An operation of the electronic device 101 transmitting the dummy SMS to notify the recovery may be referred to as a “polling action.” By notifying the NTN core network of the recovery of the electronic device 101, the electronic device 101 may induce retransmission of a missed SMS.

In an embodiment of the present disclosure, the non-terrestrial wireless communication device 220 may, in operation 715, notify the NTN core network 520 of the recovery of the electronic device 101. In an embodiment of the present disclosure, the NTN core network 520 may, in operation 717, request an SMS server 550 (e.g., an SMS center of the TN provider) to transmit a pending SMS. In an embodiment of the present disclosure, the SMS server 550 may, in operation 719, transmit the pending SMS message to the NTN core network 520 based on the polling action by the electronic device 101. In an embodiment of the present disclosure, the NTN core network 520 may, in operation 721, relay SMS delivery. For example, the NTN core network 520 may deliver the missed SMS message to the non-terrestrial wireless communication device 220. The non-terrestrial wireless communication device 220 may transmit the missed SMS message to the electronic device 101. The electronic device 101 may improve possibility of retransmitting the missed SMS based on calculation of T_rec.

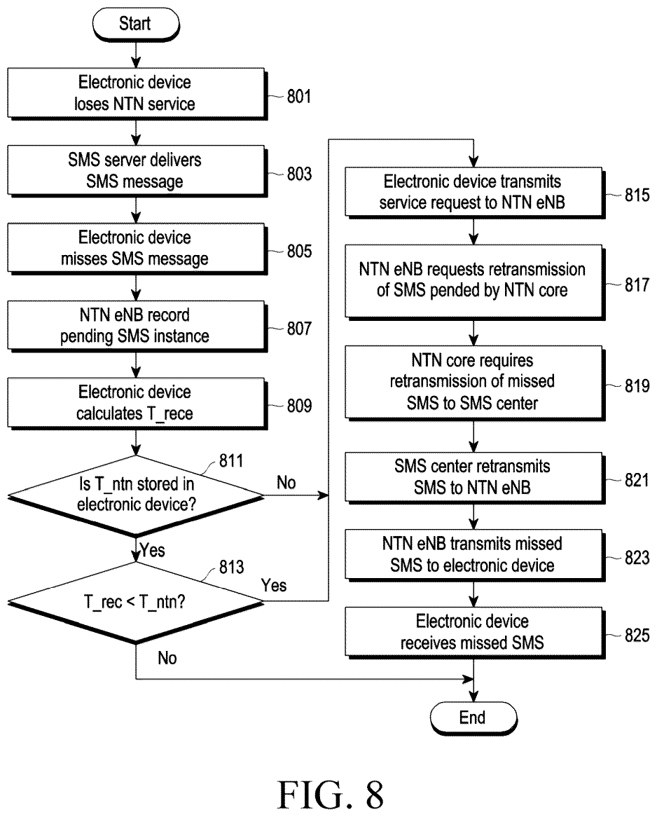

FIG. 8 is a diagram for describing an operating method of an electronic device according to an embodiment.

In an embodiment of the present disclosure, content overlapping with FIGS. 6 and 7 may not be repeated in FIG. 8.

According to an embodiment of the present disclosure, an electronic device 101 may, in operation 801, identify loss of an NTN service. In an embodiment, an SMS server (e.g., an SMS server 550) may, in operation 803, transmit an SMS message to the electronic device 101.

In an embodiment of the present disclosure, the electronic device 101 may, in operation 805, miss the SMS message.

In an embodiment of the present disclosure, an NTN eNodeB(eNB) (e.g., a non-terrestrial wireless communication device 220) may, in operation 807, may record a pending SMS instance until an expiration of a timer (e.g., T_ntn).

In an embodiment of the present disclosure, the electronic device 101 may, in operation 809, identify recovery of the NTN service and a time period (e.g., T_rec) for the service loss. In an embodiment of the present disclosure, the electronic device 101 may, in operation 811, identify whether a value of the timer (e.g., T_ntn) is stored in the electronic device 101. In an embodiment of the present disclosure, a plurality of timer values corresponding to an NTN provider may be also stored in the electronic device 101.

In an embodiment of the present disclosure, after the recovery of the NTN service, the electronic device 101 may transmit, to a satellite, a request for message delivery, based on information associated with a threshold time period being not set.

In an embodiment of the present disclosure, based on identifying that the value of the timer is stored in the electronic device 101 (Operation 811—Yes), the electronic device 101 may, in operation 813, identify whether the time period for the service loss is less than the value of the timer. In an embodiment of the present disclosure, operation 813 may be optionally performed. For example, based on a fact that the electronic device 101 may use an NTN service of a service provider which has not set a timer value, the electronic device 101 may transmit a service request to the NTN eNB without comparing the time period for the service loss with the timer value.

In an embodiment of the present disclosure, based on identifying that the time period for the service loss is less than the timer value (Operation 813—Yes), the electronic device 101 may, in operation 815, transmit a service request to the NTN eNB. The service request may include, for example, at least one of an NIDD service request, a TAU request, or a dummy SMS message.

In an embodiment of the present disclosure, the NTN eNB may, in operation 817, request a retransmission of a pended SMS to an NTN core (e.g., an NTN core network 520). In an embodiment of the present disclosure, the NTN core may, in operation 819, require a retransmission of a missed SMS to an SMS center (e.g., an SMS server 550). In an embodiment of the present disclosure, the SMS center may, in operation 821, retransmit the SMS message to the NTN eNB. For example, the SMS center may deliver the missed SMS message to the NTN core network. The NTN core network may deliver the missed SMS message to the NTN eNB.

In an embodiment of the present disclosure, the NTN eNB may transmit the missed SMS message to the electronic device 101 in operation 823. In an embodiment of the present disclosure, the electronic device 101 may receive the missed SMS message in operation 825. In an embodiment of the present disclosure, the electronic device 101 may improve possibility of retransmission of the missed SMS by notifying the network of the recovery of the electronic device 101 before a timer for storing a pending SMS message expires.

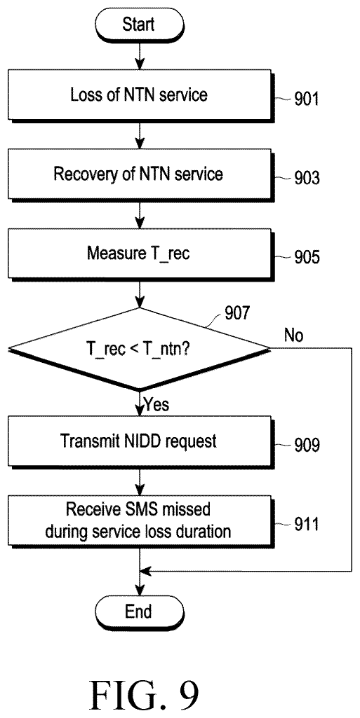

FIG. 9 is a diagram for describing an operating method of an electronic device according to an embodiment of the present disclosure.

In an embodiment of the present disclosure, content overlapping with FIGS. 6 to 8 may not be repeated in FIG. 9.

According to an embodiment of the present disclosure, an electronic device 101 may, in operation 901, identify loss of an NTN service. According to an embodiment of the present disclosure, the electronic device 101 may, in operation 903, identify recovery of the NTN service.

According to an embodiment of the present disclosure, the electronic device 101 may, in operation 905, measure a time period (e.g., T_rec) for service loss. In an embodiment of the present disclosure, the electronic device 101 may, in operation 907, identify whether the time period (T_rec) for the service loss is less than a timer (T_ntn) value.

In an embodiment of the present disclosure, based on identifying that the time period for the service loss is less than the timer value (Operation 907—Yes), the electronic device 101 may, in operation 909, transmit an NIDD request.

In an embodiment of the present disclosure, the electronic device 101 may receive a missed SMS message during a service loss duration in operation 911. In an embodiment of the present disclosure, the electronic device 101 may improve possibility of retransmission of the missed SMS by notifying the network of the recovery of the electronic device 101 based on the NIDD request before the expiration of a timer (T_ntn) for storing a pending SMS message.

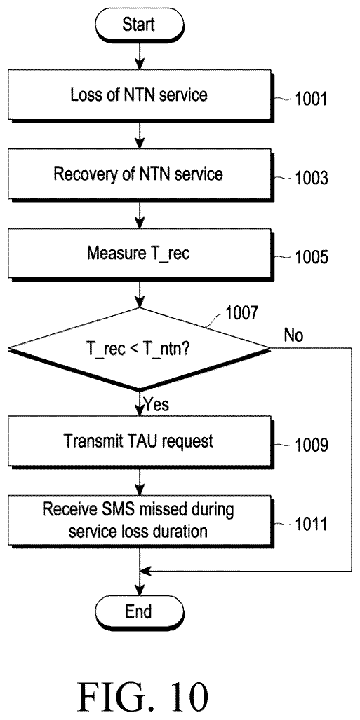

FIG. 10 is a diagram for describing an operating method of an electronic device according to an embodiment of the present disclosure.

In an embodiment of the present disclosure, content overlapping with FIGS. 6 to 9 may not be repeated in FIG. 10.

According to an embodiment of the present disclosure, an electronic device 101 may, in operation 1001, identify loss of an NTN service. According to an embodiment of the present disclosure, the electronic device 101 may, in operation 1003, identify recovery of the NTN service.

According to an embodiment of the present disclosure, the electronic device 101 may, in operation 1005, measure a time period (e.g., T_rec) for service loss. In an embodiment of the present disclosure, the electronic device 101 may, in operation 1007, identify whether the time period (T_rec) for the service loss is less than a timer (T_ntn) value.

In an embodiment of the present disclosure, based on identifying that the time period for the service loss is less than the timer value (Operation 1007—Yes), the electronic device 101 may, in operation 1009, transmit a TAU request. In an embodiment of the present disclosure, the electronic device 101 may, in operation 1011, receive a missed SMS messages during a service loss duration. In an embodiment of the present disclosure, the electronic device 101 may improve possibility of retransmission of the missed SMS by notifying the network of the recovery of the electronic device 101 based on the TAU request before expiration of the timer (T_ntn) for storing a pending SMS message.

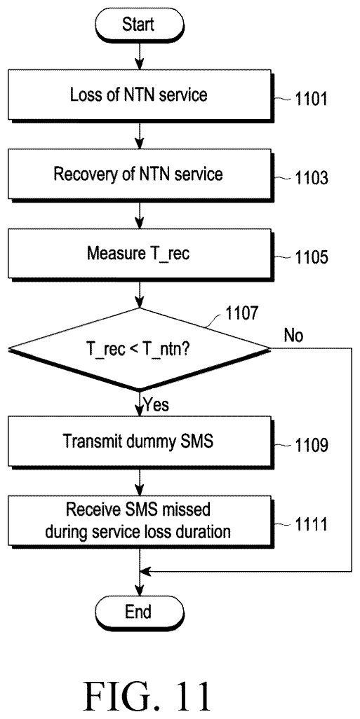

FIG. 11 is a diagram for describing an operating method of an electronic device according to an embodiment of the present disclosure.

In an embodiment of the present disclosure, content overlapping with FIGS. 6 to 10 may not be repeated in FIG. 11.

According to an embodiment of the present disclosure, an electronic device 101 may, in operation 1101, identify loss of an NTN service. According to an embodiment of the present disclosure, the electronic device 101 may, in operation 1103, identify recovery of the NTN service.

According to an embodiment of the present disclosure, the electronic device 101 may, in operation 1105, measure a time period (e.g., T_rec) for service loss. In an embodiment of the present disclosure, the electronic device 101 may, in operation 1107, identify whether the time period (T_rec) for the service loss is less than a timer (T_ntn) value.

In an embodiment of the present disclosure, based on identifying that the time period for the service loss is less than the timer value (Operation 1107—Yes), the electronic device 101 may, in operation 1109, transmit a dummy SMS. In an embodiment of the present disclosure, the electronic device 101 may, in operation 1111, receive a missed SMS messages during a service loss duration. In an embodiment of the present disclosure, the electronic device 101 may improve possibility of retransmission of the missed SMS by notifying the network of the recovery of the electronic device 101 based on the dummy SMS before expiration of the timer (T_ntn) for storing a pending SMS message.

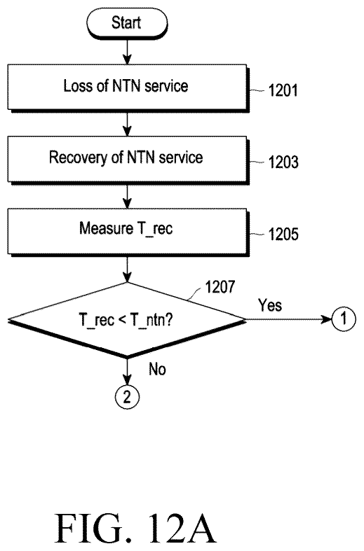

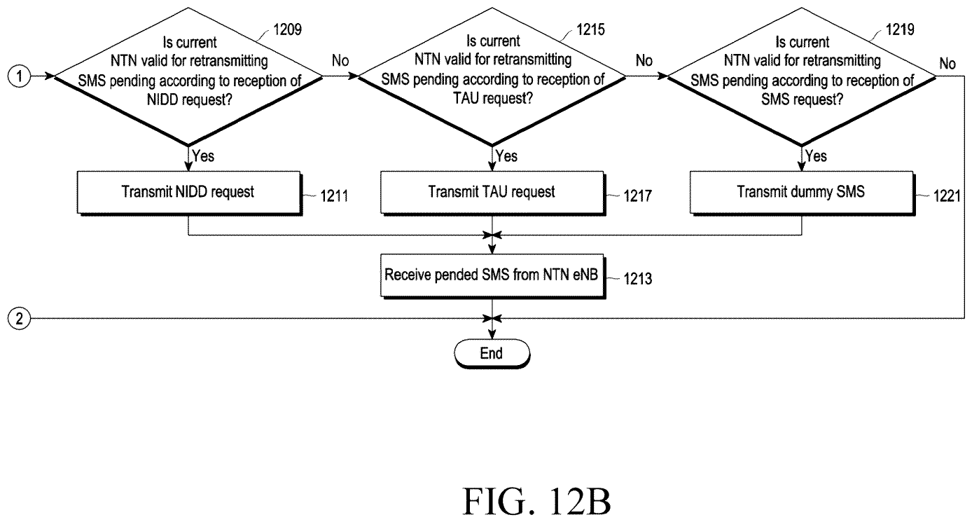

FIG. 12A is a diagram for describing an operating method of an electronic device according to an embodiment of the present disclosure.

FIG. 12B is a diagram for describing an operating method of an electronic device according to an embodiment of the present disclosure.

In an embodiment of the present disclosure, content overlapping with FIGS. 6 to 11 may not be repeated in FIGS. 12A and 12B.

Referring to FIG. 12A, an electronic device 101 may, in operation 1201, identify loss of an NTN service. According to an embodiment of the present disclosure, the electronic device 101 may, in operation 1203, identify recovery of the NTN service.

According to an embodiment of the present disclosure, the electronic device 101 may, in operation 1205, measure a time period (e.g., T_rec) for service loss.

In an embodiment of the present disclosure, the electronic device 101 may, in operation 1207, identify whether the time period (T_rec) for the service loss is less than a timer (T_ntn) value. In an embodiment of the present disclosure, based on identifying that the time period for the service loss is less than the timer value (Operation 1207—Yes), the electronic device 101 may, in operation 1209, identify whether a current NTN is valid for retransmitting an SMS which is pending according to reception of an NIDD request. The electronic device 101 may store a plurality of service request types set in response to a plurality of NTN providers in order to notify a network of the recovery of the electronic device 101. The electronic device 101 may identify a service request type corresponding to a network (e.g., a network of an NTN provider) among the plurality of service request types. For example, the electronic device 101 may identify whether a service request set in order to notify the network of the recovery of the electronic device 101 corresponds to the NIDD request.

In an embodiment of the present disclosure, based on identifying that the current NTN is valid for retransmitting the SMS which is pending according to the reception of the NIDD request (Operation 1209—Yes), the electronic device 101 may, in operation 1211, transmit the NIDD request to an NTN eNB (e.g., a satellite). The NIDD request may include, for example, at least an identifier of the electronic device 101, non-IP data, and/or a destination address of data, and specific information included in the NIDD request is not limited to an examples described above. Referring to FIG. 12B, in an embodiment of the present disclosure, the electronic device 101 may receive a pended SMS message from the NTN eNB in operation 1213. In an embodiment, based on identifying that the current NTN is not valid for retransmitting the SMS which is pending according to the reception of the NIDD request (Operation 1209—No), the electronic device 101 may, in operation 1215, identify whether the current NTN is valid for retransmitting an SMS which is pending according to reception of a TAU request. For example, the electronic device 101 may identify whether a service request set to notify the network of the recovery of the electronic device 101 corresponds to the TAU request.

In an embodiment of the present disclosure, based on identifying that the current NTN is valid for retransmitting the SMS which is pending according to the reception of the TAU request (Operation 1215—Yes), the electronic device 101 may, in operation 1217, transmit the TAU request to the NTN eNB. The TAU request may include at least information related to a location of the electronic device 101, and specific information included in the TAU request is not limited to an example described above. In an embodiment of the present disclosure, after transmitting the TAU request, the electronic device 101 may, in operation 1213, receive the pended SMS message from the NTN eNB.

In an embodiment of the present disclosure, based on identifying that the current NTN is not valid for retransmitting the SMS which is pending according to the reception of the TAU request (Operation 1215—No), the electronic device 101 may, in operation 1219, identify whether the current NTN is valid for retransmitting an SMS which is pending according to an SMS request. For example, the electronic device 101 may identify whether the service request set to notify the network of the recovery of the electronic device 101 corresponds to a dummy SMS.

In an embodiment of the present disclosure, based on identifying that the current NTN is valid for retransmitting the SMS which is pending according to the SMS request (Operation 1219—Yes), the electronic device 101 may, in operation 1221, transmit the dummy SMS to the NTN eNB. The dummy SMS may include a dummy value. A recipient of the dummy SMS may be, for example, a phone number of the electronic device 101. In an embodiment, after transmitting the dummy SMS, the electronic device 101 may, in operation 1213, receive the pended SMS message from the NTN eNB. In an embodiment, the electronic device 101 may improve possibility of retransmitting the missed SMS by notifying the network of the recovery of the electronic device 101 based on the service request before a timer (T_ntn) for storing the pending SMS message expires. In FIGS. 12A and 12B, transmission of the NIDD request, transmission of the TAU request, or transmission of the SMS request is selectively performed, but is not limited thereto. For example, the electronic device 101 may transmit the NIDD request and the TAU request to notify the network of the service recovery of the electronic device 101 based on a service request type set corresponding to a provider of the network. The electronic device 101 may also transmit the TAU request and the dummy SMS to notify the network of the service recovery of the electronic device 101 based on the service request type set corresponding to the provider of the network. The electronic device 101 may also transmit the NIDD request and the dummy SMS to notify the network of the service recovery of the electronic device 101 based on the service request type set corresponding to the provider of the network. The electronic device 101 may transmit the NIDD request, the TAU request, and the dummy SMS to notify the network of the service recovery of the electronic device 101 based on the service request type set corresponding to the provider of the network. The service request transmitted by the electronic device 101 to notify the network of the service recovery of the electronic device 101 is not limited to an example described above. In an embodiment of the present disclosure, at least one of operation 1209, operation 1215, or operation 1219 may be omitted. For example, the electronic device 101 may perform operation 1215 without performing operation 1209. The electronic device 101 may also perform operation 1219 without performing operations 1209 and 1215.

According to an embodiment of the present disclosure, an electronic device (101) may comprise communication circuitry (192) configured to transmit or receive a signal associated with an NTN communication, at least one processor (120) including processing circuitry, and memory (130) storing instructions.

According to an embodiment of the present disclosure, the instructions, when executed by the at least one processor individually or collectively, may cause the electronic device to, after connecting to a satellite for an NTN service, identify that the NTN service is lost.

According to an embodiment of the present disclosure, the instructions, when executed by the at least one processor individually or collectively, may cause the electronic device to, after identifying that the NTN service is lost, identify that the NTN service is recovered.

According to an embodiment of the present disclosure, the instructions, when executed by the at least one processor individually or collectively, may cause the electronic device to, based on identifying that the NTN service is recovered, automatically transmit, to the satellite, via the communication circuitry, a signal for causing transmission of one or more messages which failed to be transmitted to the electronic device during a time period between a first time point at which the NTN service is lost and a second time point at which the NTN service is recovered.

According to an embodiment of the present disclosure, the instructions, when executed by the at least one processor individually or collectively, may cause the electronic device to receive, from the satellite, via the communication circuitry, at least one of the one or more messages.

According to an embodiment of the present disclosure, the one or more messages may comprise at least one short message service (SMS) message.

According to an embodiment of the present disclosure, the signal may comprise a dummy SMS message, and a destination of the dummy SMS message may comprise a phone number corresponding to the electronic device.

According to an embodiment of the present disclosure, the instructions, when executed by the at least one processor individually or collectively, may cause the electronic device to receive, via the communication circuitry, the dummy SMS message and the one or more messages which failed to be transmitted to the electronic device during the time period between the first time point at which the NTN service is lost and the second time point at which the NTN network service is recovered.

According to an embodiment of the present disclosure, the instructions, when executed by the at least one processor individually or collectively, may cause the electronic device to, based on the time period between the first time point at which the NTN service is lost and the second time point at which the NTN service is recovered being shorter than a threshold time period, transmit, to the satellite, via the communication circuitry, the signal for causing transmission of the one or more messages which failed to be transmitted to the electronic device during the time period between the first time point at which the NTN service is lost and the second time point at which the NTN service is recovered.

According to an embodiment of the present disclosure, the threshold time period may correspond to a value for storing information associated with a failure of message transmission by the satellite.

According to an embodiment of the present disclosure, the threshold time period may be defined by an operator of the NTN service.

According to an embodiment of the present disclosure, the at least one of the one or more messages, which failed to be transmitted to the electronic device during the threshold time period, may be received from the satellite.

According to an embodiment of the present disclosure, the signal may comprise at least one of a non-internet protocol (IP) data delivery (NIDD) service request, a tracking area update (TAU) request, or a dummy short message service (SMS) message.

According to an embodiment of the present disclosure, the one or more messages may comprise at least one of a short message service (SMS) message, a multimedia messaging service (MMS) message, or a rich communication service (RCS) message.

According to an embodiment of the present disclosure, an operating method of an electronic device (101) may comprise, after connecting to a satellite for a NTN service, identifying that the NTN service is lost.

According to an embodiment of the present disclosure, the operating method of the electronic device (101) may comprise, after identifying that the NTN service is lost, identifying that the NTN service is recovered.

According to an embodiment of the present disclosure, the operating method of the electronic device (101) may comprise, based on identifying that the NTN service is recovered, automatically transmitting, to the satellite, a signal for causing transmission of one or more messages which failed to be transmitted to the electronic device during a time period between a first time point at which the NTN service is lost and a second time point at which the NTN service is recovered.

According to an embodiment of the present disclosure, the operating method of the electronic device (101) may comprise, receiving, from the satellite, at least one of the one or more messages.

According to an embodiment of the present disclosure, the one or more messages may comprise at least one short message service (SMS) message.

According to an embodiment of the present disclosure, the signal may comprise a dummy SMS message, and a destination of the dummy SMS message may comprise a phone number corresponding to the electronic device.

According to an embodiment of the present disclosure, receiving, from the satellite, the at least one of the one or more messages may comprise receiving the dummy SMS message and the one or more messages which failed to be transmitted to the electronic device during the time period between the first time point at which the NTN service is lost and the second time point at which the NTN network service is recovered.

According to an embodiment of the present disclosure, based on identifying that the NTN service is recovered, automatically transmitting, to the satellite, the signal for causing the transmission of the one or more messages which failed to be transmitted to the electronic device during the time period between the first time point at which the NTN service is lost and the second time point at which the NTN service is recovered may comprise, based on the time period between the first time point at which the NTN service is lost and the second time point at which the NTN service is recovered being shorter than a threshold time period, transmitting, to the satellite, the signal for causing transmission of the one or more messages which failed to be transmitted to the electronic device during the time period between the first time point at which the NTN service is lost and the second time point at which the NTN service is recovered.

According to an embodiment of the present disclosure, the threshold time period may correspond to a value for storing information associated with a failure of message transmission by the satellite.

According to an embodiment of the present disclosure, the threshold time period may be defined by an operator of the NTN service.

According to an embodiment of the present disclosure, the at least one of the one or more messages, which failed to be transmitted to the electronic device during the threshold time period, may be received from the satellite.

According to an embodiment of the present disclosure, the signal may comprise at least one of a non-internet protocol (IP) data delivery (NIDD) service request, a tracking area update (TAU) request, or a dummy short message service (SMS) message.

According to an embodiment of the present disclosure, the one or more messages may comprise at least one of a short message service (SMS) message, a multimedia messaging service (MMS) message, or a rich communication service (RCS) message.

According to an embodiment of the present disclosure, a storage medium storing computer-readable instructions may be provided.

According to an embodiment of the present disclosure, the instructions, when executed by at least one processor (120) of an electronic device (101), may cause the electronic device to perform at least one operation.

According to an embodiment of the present disclosure, the at least one operation may comprise, after connecting to a satellite for an NTN service, identifying that the NTN service is lost.

According to an embodiment of the present disclosure, the at least one operation may comprise, after identifying that the NTN service is lost, identifying that the NTN service is recovered.

According to an embodiment of the present disclosure, the at least one operation may comprise, based on identifying that the NTN service is recovered, automatically transmitting, to the satellite, a signal for causing transmission of one or more messages which failed to be transmitted to the electronic device during a time period between a first time point at which the NTN service is lost and a second time point at which the NTN service is recovered.

According to an embodiment of the present disclosure, the at least one operation may comprise receiving, from the satellite, at least one of the one or more messages.

According to an embodiment of the present disclosure, the one or more messages may comprise at least one short message service (SMS) message.

According to an embodiment of the present disclosure, the signal may comprise a dummy SMS message, wherein a destination of the dummy SMS message comprises a phone number corresponding to the electronic device.

According to an embodiment of the present disclosure, receiving, from the satellite, the at least one of the one or more messages may comprise receiving the dummy SMS message and the one or more messages which failed to be transmitted to the electronic device during the time period between the first time point at which the NTN service is lost and the second time point at which the NTN network service is recovered.

According to an embodiment of the present disclosure, based on identifying that the NTN service is recovered, automatically transmitting, to the satellite, the signal for causing the transmission of the one or more messages which failed to be transmitted to the electronic device during the time period between the first time point at which the NTN service is lost and the second time point at which the NTN service is recovered comprises: based on the time period between the first time point at which the NTN service is lost and the second time point at which the NTN service is recovered being shorter than a threshold time period, transmitting, to the satellite, the signal for causing transmission of the one or more messages which failed to be transmitted to the electronic device during the time period between the first time point at which the NTN service is lost and the second time point at which the NTN service is recovered

According to an embodiment of the present disclosure, the threshold time period may correspond to a value for storing information associated with a failure of message transmission by the satellite.

According to an embodiment of the present disclosure, the threshold time period mat be defined by an operator of the NTN service.

According to an embodiment of the present disclosure, the at least one of the one or more messages, which failed to be transmitted to the electronic device during the threshold time period, may be received from the satellite.

According to an embodiment of the present disclosure, the signal may comprise at least one of a non-internet protocol (IP) data delivery (NIDD) service request, a tracking area update (TAU) request, or a dummy short message service (SMS) message.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to an embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
communication circuitry;
at least one processor including processing circuitry; and
memory storing instructions that, when executed by the at least one processor individually or collectively, cause the electronic device to:
after a satellite for a non-terrestrial network (NTN) service is connected, identify that the NTN service is lost,
after the NTN service is identified as lost, identify that the NTN service is recovered,
based on identification that the NTN service is recovered, automatically transmit, to the satellite, via the communication circuitry, a signal for causing transmission of one or more messages which failed to be transmitted to the electronic device during a time period between a first time point at which the NTN service is lost and a second time point at which the NTN service is recovered, and
receive, from the satellite, via the communication circuitry, the one or more messages.

2. The electronic device of claim 1,
wherein the one or more messages comprise at least one short message service (SMS) message,
wherein the signal comprises a dummy SMS message, a destination of the dummy SMS message including a phone number corresponding to the electronic device, and
wherein the instructions, when executed by the at least one processor individually or collectively, cause the electronic device to:
receive, via the communication circuitry, the dummy SMS message and the one or more messages failed to be transmitted to the electronic device during the time period between the first time point at which the NTN service is lost and the second time point at which the NTN service is recovered.

3. The electronic device of claim 1,
wherein the instructions, when executed by the at least one processor individually or collectively, cause the electronic device to:
based on the time period between the first time point at which the NTN service is lost and the second time point at which the NTN service is recovered being shorter than a threshold time period, transmit, to the satellite, via the communication circuitry, the signal for causing transmission of the one or more messages which failed to be transmitted to the electronic device during the time period between the first time point at which the NTN service is lost and the second time point at which the NTN service is recovered, and
wherein the threshold time period corresponds to a value for storing information associated with a failure of message transmission by the satellite.

4. The electronic device of claim 3,
wherein the threshold time period is defined by an operator of the NTN service.

5. The electronic device of claim 3,
wherein the one or more messages, which failed to be transmitted to the electronic device during the threshold time period, are received from the satellite.

6. The electronic device of claim 1,
wherein the signal comprises at least one of a non-internet protocol (IP) data delivery (NIDD) service request, a tracking area update (TAU) request, or a dummy short message service (SMS) message.

7. The electronic device of claim 1,
wherein the one or more messages comprise at least one of a short message service (SMS) message, a multimedia messaging service (MMS) message, or a rich communication service (RCS) message.

8. A method of operating an electronic device, the method comprising:
after connecting to a satellite for a non-terrestrial network (NTN) service, identifying that the NTN service is lost;
after identifying that the NTN service is lost, identifying that the NTN service is recovered;
based on identifying that the NTN service is recovered, automatically transmitting, to the satellite, a signal for causing transmission of one or more messages which failed to be transmitted to the electronic device during a time period between a first time point at which the NTN service is lost and a second time point at which the NTN service is recovered; and
receiving, from the satellite, the one or more messages.

9. The method of claim 8,
wherein the one or more messages comprise at least one short message service (SMS) message,
wherein the signal comprises a dummy SMS message, a destination of the dummy SMS message including a phone number corresponding to the electronic device, and
wherein receiving, from the satellite, the one or more messages comprises:
receiving the dummy SMS message and the one or more messages which failed to be transmitted to the electronic device during the time period between the first time point at which the NTN service is lost and the second time point at which the NTN service is recovered.

10. The method of claim 8,
wherein automatically transmitting, to the satellite, the signal further comprises:
based on the time period between the first time point at which the NTN service is lost and the second time point at which the NTN service is recovered being shorter than a threshold time period, transmitting, to the satellite, the signal for causing transmission of the one or more messages which failed to be transmitted to the electronic device during the time period between the first time point at which the NTN service is lost and the second time point at which the NTN service is recovered, and
wherein the threshold time period corresponds to a value for storing information associated with a failure of message transmission by the satellite.

11. The method of claim 10,
wherein the threshold time period is defined by an operator of the NTN service.

12. The method of claim 11,
wherein the one or more messages, which failed to be transmitted to the electronic device during the threshold time period, are received from the satellite.

13. The method of claim 8,
wherein the signal includes at least one of a non-internet protocol (IP) data delivery (NIDD) service request, a tracking area update (TAU) request, or a dummy short message service (SMS) message.

14. The method of claim 8,
wherein the one or more messages include at least one of a short message service (SMS) message, a multimedia messaging service (MMS) message, or a rich communication service (RCS) message.

15. A non-transitory storage medium storing computer-readable instructions, the instructions, when executed by at least one processor of an electronic device, causing the electronic device to:
after connecting to a satellite for a non-terrestrial network (NTN) service, identify that the NTN service is lost;
after identifying that the NTN service is lost, identify that the NTN service is recovered;
based on identifying that the NTN service is recovered, automatically transmit, to the satellite, a signal for causing transmission of one or more messages which failed to be transmitted to the electronic device during a time period between a first time point at which the NTN service is lost and a second time point at which the NTN service is recovered; and
receive, from the satellite, at least one of the one or more messages.

16. The non-transitory storage medium of claim 15,
wherein the one or more messages comprise at least one short message service (SMS) message,
wherein the signal comprises a dummy SMS message, wherein a destination of the dummy SMS message comprises a phone number corresponding to the electronic device, and
wherein the instructions that cause the electronic device to receive, from the satellite, the at least one of the one or more messages further comprise instructions to cause the electronic device to:
receive the dummy SMS message and the one or more messages which failed to be transmitted to the electronic device during the time period between the first time point at which the NTN service is lost and the second time point at which the NTN service is recovered.

17. The non-transitory storage medium of claim 15,
wherein the instructions that cause the electronic device to automatically transmit, to the satellite, the signal further comprise instructions to cause the electronic device to:
based on the time period between the first time point at which the NTN service is lost and the second time point at which the NTN service is recovered being shorter than a threshold time period, transmit, to the satellite, the signal for causing transmission of the one or more messages which failed to be transmitted to the electronic device during the time period between the first time point at which the NTN service is lost and the second time point at which the NTN service is recovered, and
wherein the threshold time period corresponds to a value for storing information associated with a failure of message transmission by the satellite.

18. The non-transitory storage medium of claim 17,
wherein the threshold time period is defined by an operator of the NTN service.

19. The non-transitory storage medium of claim 18,
wherein the one of the one or more messages, which failed to be transmitted to the electronic device during the threshold time period, is received from the satellite.

20. The non-transitory storage medium of claim 15,
wherein the signal comprises at least one of a non-internet protocol (IP) data delivery (NIDD) service request, a tracking area update (TAU) request, or a dummy short message service (SMS) message.
